(19) United States
(12) Patent Application Publication
(10) Pub. No.: US 2024/0427223 A1
(43) Pub. Date: Dec. 26, 2024

(54) FOCUSING MODULE AND PROJECTOR

(71) Applicant: Coretronic Corporation, Hsin-Chu (TW)

(72) Inventor: Yen-Ming Tseng, Hsin-Chu (TW)

(73) Assignee: Coretronic Corporation, Hsin-Chu (TW)

(21) Appl. No.: 18/749,588

(22) Filed: Jun. 20, 2024

(30) Foreign Application Priority Data
Jun. 26, 2023 (CN) 202310754805.4

(51) Int. Cl. G03B 21/14; G02B 7/08

(52) U.S. Cl. CPC G03B 21/142; G02B 7/08

(57) ABSTRACT

The focusing module suitable for a lens module includes a focusing ring having a first maximum rotation stroke and being suitable for rotation to adjust the focal length of the lens module. The focusing module connected to the focusing ring includes a bracket, a drive unit disposed on the bracket, a relay gear connected to the drive unit, a first structure formed on the bracket, and a second structure formed on the relay gear. The focusing ring is connected to the relay gear, and the drive unit is configured to drive the relay gear to rotate to drive the focusing ring to rotate. When the relay gear rotates relatively to the bracket, the first structure and the second structure are suitable for stopping each other to limit rotation of the relay gear, so that the relay gear has a second maximum rotation stroke smaller than the first maximum rotation stroke.

### CROSS-REFERENCE TO RELATED APPLICATION

This application claims the priority benefit of China application serial no. 202310754805.4, filed on Jun. 26, 2023. The entirety of the above-mentioned patent application is hereby incorporated by reference herein and made a part of this specification.

### BACKGROUND

### Technical Field

The disclosure relates to an optical device and a focusing module thereof, in particular to a projector and a focusing module thereof.

### Description of Related Art

The projector generally has a focusing module, which uses a motor to drive a focusing ring on a lens module to rotate in order to adjust the focus of the lens module. In terms of a plug-in focusing module, which is not disposed in the lens module, when the motor of the focusing module drives the focusing ring to rotate to a limit position and a user fails to stop the motor from outputting in time, the output force provided to the focusing ring by the motor acts on the lens module as a thrust force, causing an image projected by the lens module to jitter or shift. Moreover, if the motor continues to provide the output force to the focusing ring repeatedly for a long time after the focusing ring reaches the limit position, the reaction force borne by the focusing module may lead to structural loss of the focusing module.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a focusing module suitable for a lens module. The lens module includes a focusing ring, and the focusing ring has a first maximum rotation stroke. The focusing ring is suitable for rotation to adjust the focal length of the lens module. The focusing module is connected to the focusing ring and includes a bracket, a drive unit, a relay gear, a first structure, and a second structure. The drive unit is disposed on the bracket. The relay gear is disposed on the bracket and connected to the drive unit. The focusing ring is connected to the relay gear, and the drive unit is configured to drive the relay gear to rotate to drive the focusing ring to rotate. The first structure is formed on the bracket. The second structure is formed on the relay gear. When the relay gear rotates relatively to the bracket, the first structure and the second structure are suitable for stopping each other to limit rotation of the relay gear, so that the relay gear has a second maximum rotation stroke, and the second maximum rotation stroke is smaller than the first maximum rotation stroke.

An embodiment of the disclosure provides a projector including an illumination module, a light valve, a lens module, and a focusing module. The illumination module is configured to provide an illumination light beam. The light valve is disposed on the transmission path of the illumination light beam and configured to convert the illumination light beam into an image light beam. The lens module is disposed on the transmission path of the image light beam and configured to project the image light beam. The lens module includes a focusing ring, the focusing ring has a first maximum rotation stroke, and the focusing ring is suitable for rotation to adjust the focal length of the lens module. The focusing module is connected to the focusing ring. The focusing module includes a bracket, a drive unit, a relay gear, a first structure, and a second structure. The drive unit is disposed on the bracket. The relay gear is disposed on the bracket and connected to drive unit. The focusing ring is connected to the relay gear, and the drive unit is configured to drive the relay gear to rotate to drive the focusing ring to rotate. The first structure is formed on the bracket. The second structure is formed on the relay gear. When the relay gear rotates relatively to the bracket, the first structure and the second structure are suitable for stopping each other to limit rotation of the relay gear, so that the relay gear has a second maximum rotation stroke, and the second maximum rotation stroke is smaller than the first maximum rotation stroke.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projector according to an embodiment of the disclosure.

FIG. 2 is a perspective view of a partial structure of the projector in FIG. 1.

FIG. 3 is a perspective view of a lens module in FIG. 2.

FIG. 4A to FIG. 4C are schematic views of a relay gear rotating to different states according to an embodiment of FIG. 2.

FIG. 5 is a schematic view of some components of a focusing module according to another embodiment of the disclosure.

FIG. 6 is a perspective view of a relay gear according to FIG. 5.

FIG. 7 is a perspective view of a bracket and a drive unit according to FIG. 5.

FIG. 8A to FIG. 8C are schematic views of the relay gear rotating to different states according to FIG. 5.

FIG. 9 is a schematic view of some components of a focusing module according to another embodiment of the disclosure.

FIG. 10 is a perspective view of a relay gear according to FIG. 9.

FIG. 11 is a perspective view of a bracket and a drive unit according to FIG. 9.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a focusing module and a projector, which can prevent a driving force of the focusing module from shaking a projected image. Other purposes and advantages of the disclosure can be further understood from the technical features disclosed in the disclosure.

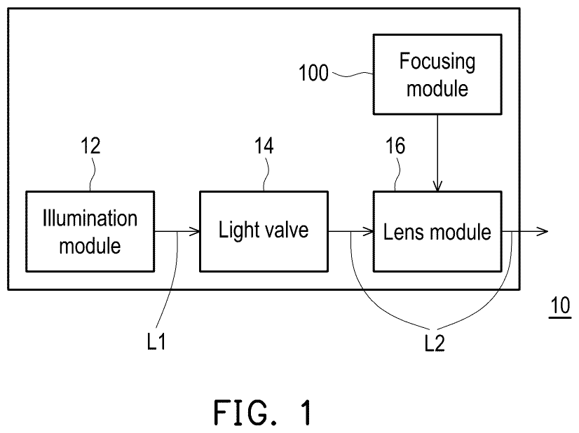

FIG. 1 is a schematic view of a projector according to an embodiment of the disclosure. Referring to FIG. 1, a projector 10 of this embodiment includes an illumination module 12, a light valve 14, a lens module 16, and a focusing module 100. The illumination module 12 is configured to provide an illumination light beam L1. The light valve 14 is disposed on the transmission path of the illumination light beam L1 and configured to convert the illumination light beam L1 into an image light beam L2. The lens module 16 is disposed on the transmission path of the image light beam L2 and configured to project the image light beam L2. The focusing module 100 is suitable for the lens module 16 and is configured to drive the lens module 16 to adjust the focal length and limit the focusing range of the lens module 16.

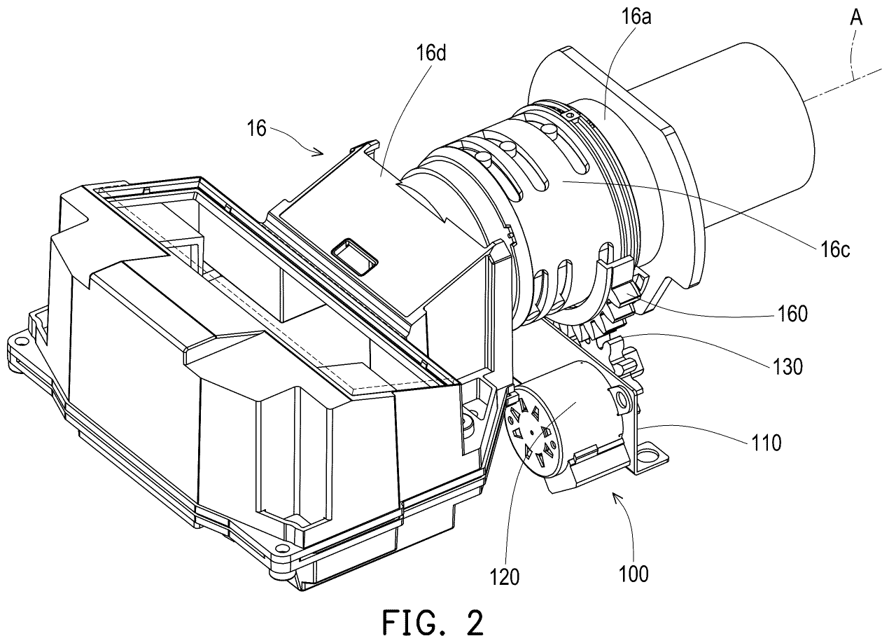

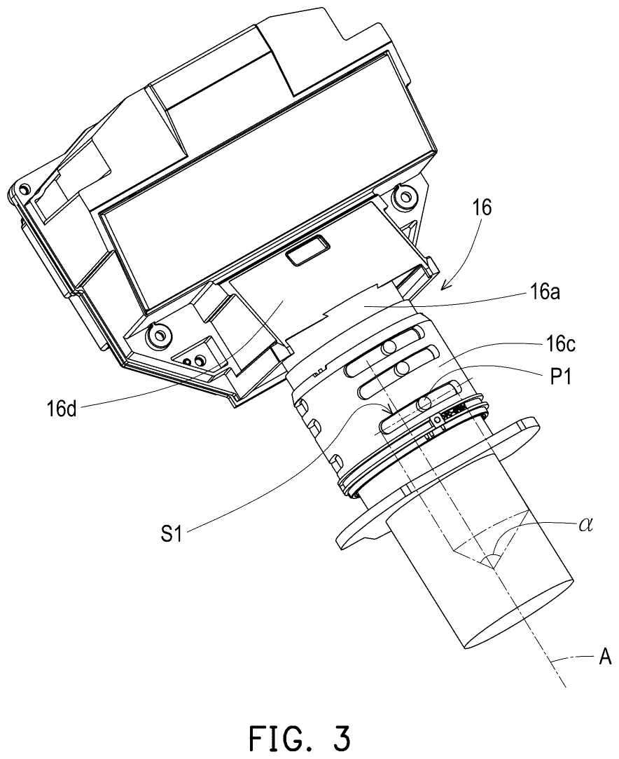

FIG. 2 is a perspective view of a partial structure of the projector in FIG. 1. FIG. 3 is a perspective view of the lens module in FIG. 2. Please refer to FIG. 2 and FIG. 3. The lens module 16 according to this embodiment includes a lens barrel 16a, a lens assembly (not shown), a focusing ring 16c, and a body 16d, the lens barrel 16a is disposed on the body 16d, the lens assembly is disposed inside the lens barrel 16a, and the focusing ring 16c is sleeved on the outer wall of the lens barrel 16a and may rotate relatively to the lens barrel 16a. In addition, the focusing ring 16c has a first maximum rotation stroke according to a rotatable range. The focusing module 100 is connected to the focusing ring 16c and configured to drive the focusing ring 16c to rotate relatively to the body 16d (or the lens barrel 16a) around an axis A (such as an optical axis of the lens module 16) as the center axis. The rotation of the focusing ring 16c can drive at least a part of the lens assembly to move around the axis A, thereby adjusting the focal length of the lens module 16.

Specifically, the focusing module 100 of this embodiment includes a bracket 110, a drive unit 120, a relay gear 130, and a driven gear 160. The drive unit 120 is, for example, a motor and the drive unit 120 is disposed on the bracket 110. The relay gear 130 is rotatable disposed on the bracket 110 and connected to the drive unit 120. The driven gear 160 is connected to the focusing ring 16c by being fixed on the focusing ring 16c, and the focusing ring 16c may be connected to the relay gear 130 through the driven gear 160. Specifically, the driven gear 160 is engaged with the relay gear 130, and the drive unit 120 is configured to drive the relay gear 130 to rotate, so that the relay gear 130 drives the focusing ring 16c to rotate through the driven gear 160.

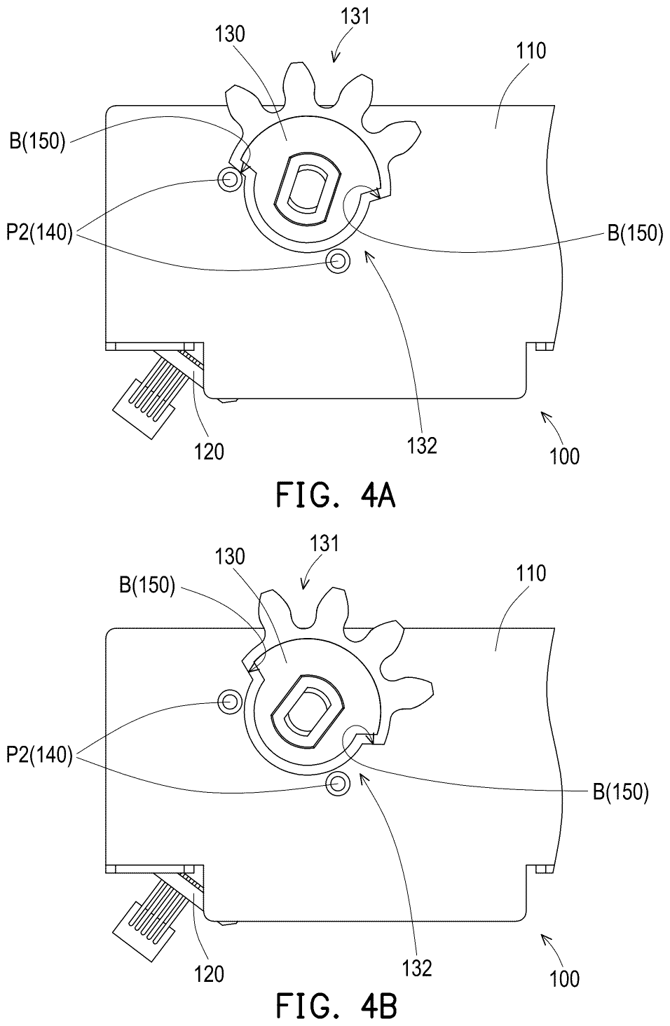

FIG. 4A to FIG. 4C are schematic views of the relay gear rotating to different states according to an embodiment of FIG. 2. Please refer to FIG. 4A to FIG. 4C. The focusing module 100 of this embodiment further includes a first structure 140 and a second structure 150, the first structure 140 is formed on the bracket 110, and the second structure 150 is formed on the relay gear 130. When the relay gear 130 rotates relatively to the bracket 110, the first structure 140 and the second structure 150 are suitable for stopping each other as shown in FIG. 4A and FIG. 4C to limit rotation of the relay gear 130, so that the relay gear 130 has a second maximum rotation stroke. The second maximum rotation stroke of the relay gear 130 is smaller than the first maximum rotation stroke of the focusing ring 16c.

As mentioned above, the second structure 150 on the relay gear 130 of this embodiment and the first structure 140 on the bracket 110 can stop each other when the relay gear 130 rotates relatively to the bracket 110, so as to limit the maximum rotation stroke of the relay gear 130 (that is, the second maximum rotation stroke) to be smaller than the maximum rotation stroke of the focusing ring 16c (that is, the first maximum rotation stroke). Accordingly, before the focusing ring 16c rotates to a limit position thereof, the relay gear 130 first rotates to a limit position thereof to stop the focusing ring 16c from continuing to rotate, so as to prevent the output force provided to the focusing ring 16c by the drive unit 120 from acting on the lens module 16 and causing the image projected by the lens module 16 to jitter or shift. Moreover, the output force can be prevented from acting on the lens module 16 to produce a reaction force on the focusing module 100, so that the focusing module 100 is not worn out due to repeated long-term bearing of the reaction force.

Please refer to FIG. 3. The focusing ring 16c of this embodiment has a limiting slot S1 (shown as three), the lens barrel 16a has a limiting column P1 (shown as three), and the limiting column P1 is positioned in the limiting slot S1. Two opposite ends of the limiting slot S1 are configured to stop the limiting column P1. That is, when either of the opposite ends of the limiting slot S1 touches the limiting column P1 as the focusing ring 16c rotates, the focusing ring 16c is at the limit position thereof. Therefore, according to the change of relative positions of the limiting column P1 and the limiting slot S1, the range by which the focusing ring 16c can be rotated is provided, so as to limit the focusing ring 16c to have the first maximum rotation stroke. In detail, since the limiting column P1 and the limiting slot S1 stops each other, the focusing ring 16c has a maximum rotation angle α, the maximum rotation angle is an included angle between the two opposite ends of the limiting slot S1 with respect to the axis A (for example, the optical axis of the lens module 16), and the first maximum rotation stroke is the distance that the focusing ring 16c moves at the maximum rotation angle α. For example, the maximum rotation angle α of the focusing ring 16c is, for example, 60 degrees, then the first maximum rotation stroke is the moving distance of the focusing ring 16c rotating 60 degrees, that is, πr/3, in which r is the radius of the focusing ring 16c. In addition, since the second maximum rotation stroke of the relay gear 130 is smaller than the first maximum rotation stroke of the focusing ring 16c, the second maximum rotation stroke of the relay gear 130 may be designed according to the maximum rotation angle α of the focusing ring 16c. For example, in the case that the maximum rotation angle α of the focusing ring 16c is 60 degrees, the second maximum rotation stroke of the relay gear 130 may be designed as the moving distance of the focusing ring 16c rotating 59 degrees. In other embodiments, the maximum rotation angle α may be other appropriate angles, and the second maximum rotation stroke may be the moving distance of the focusing ring 16c rotating slightly smaller than the maximum rotation angle α, and the disclosure is not limited thereto.

Please refer to FIG. 4A to FIG. 4C. The first structure 140 of this embodiment includes at least one limiting column P2 (shown as two) formed on the bracket 110. The relay gear 130 has a toothed area 131 and a non-toothed area 132. The toothed area 131 is engaged with the driven gear 160 and is connected to the focusing ring 16c through the driven gear 160. The non-toothed area 132 has two stopping surfaces B to form the second structure 150. The two limiting columns P2 are respectively positioned on the rotation paths of the two stopping surfaces B, and the two stopping surfaces B are respectively configured to stop the two limiting columns P2, so as to limit the relay gear 130 to have the second maximum rotation stroke. In detail, when corresponding to the rotation state shown in FIG. 4A, since one of the limiting columns P2 and one of the stopping surfaces B stop each other, the relay gear 130 is at the limit position thereof, so that the relay gear 130 can no longer rotate in the counterclockwise direction and can only rotate in the clockwise direction instead. When the relay gear 130 is in the state shown in FIG. 4B, the limiting column P2 and the stopping surface B do not stop each other, and the relay gear 130 can rotate in the clockwise or counterclockwise direction arbitrarily. When the relay gear 130 is in the state shown in FIG. 4C, another limiting column P2 and another stopping surface B stop each other, so that the relay gear 130 is at another limit position thereof, and the relay gear 130 can no longer rotate in the clockwise direction and can only rotate in the counterclockwise direction instead. Accordingly, the moving distance of the relay gear 130 rotating from the state in FIG. 4A to the state in FIG. 4C or from the state in FIG. 4C to the state in FIG. 4A is the second maximum rotation stroke. According to the change of relative positions of the limiting column P2 and the stopping surface B, the range by which the relay gear 130 can be rotated is provided, so as to limit the relay gear 130 to have the second maximum rotation stroke. It should be noted that rotating in the clockwise and counterclockwise directions described here are merely used to distinguish different rotation directions, and are not used to limit the operation of actual component rotation. In addition, although two limiting columns are used for illustration in this embodiment, in other embodiments, there may be merely one limiting column, and through the two stopping surfaces B stopping at two opposite sides of the limiting column, the relay gear 130 is limited to have the second maximum rotation stroke.

The disclosure does not limit the forms of the first structure and the second structure, which are illustrated below.

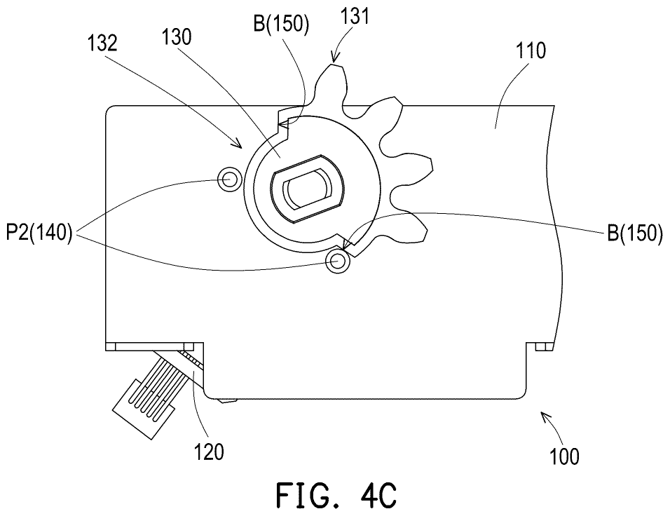

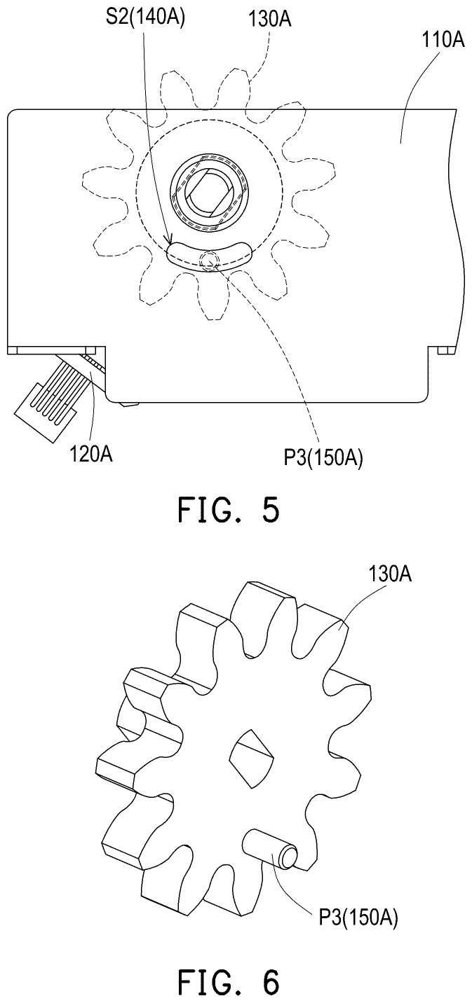

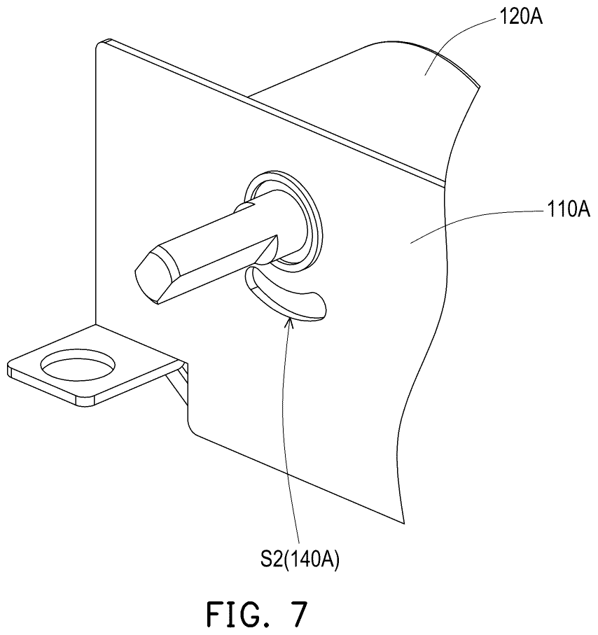

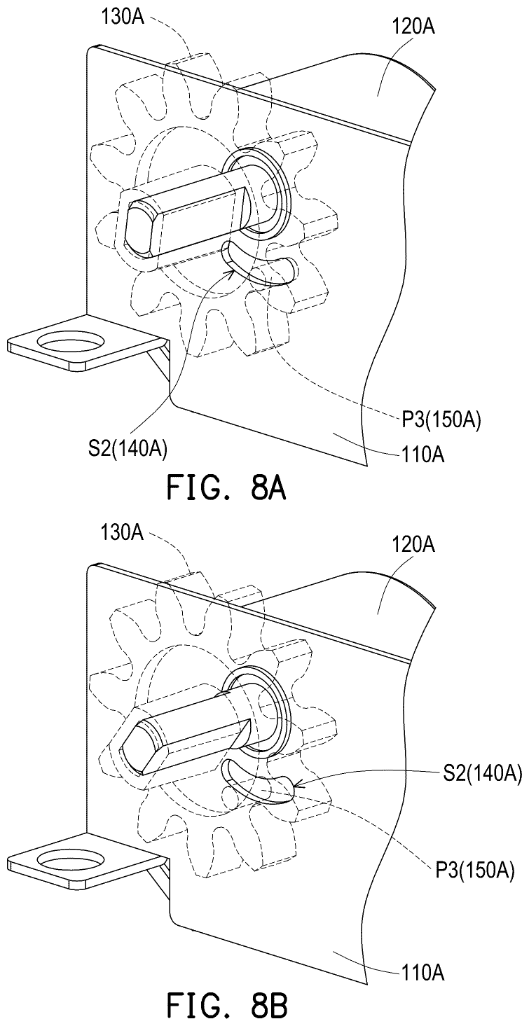

FIG. 5 is a schematic view of some components of the focusing module according to another embodiment of the disclosure. FIG. 6 is a perspective view of the relay gear according to FIG. 5. FIG. 7 is a perspective view of the bracket and drive unit according to FIG. 5. FIG. 8A to FIG. 8C are schematic views of the relay gear rotating to different states according to FIG. 5. In the embodiment shown in FIG. 5 to FIG. 8C, the configuration and action modes of a bracket 110A, a drive unit 120A, a relay gear 130A, a first structure 140A, and a second structure 150A are respectively similar to the configuration and action modes of the bracket 110, the drive unit 120, the relay gear 130, the first structure 140, and the second structure 150 in the previous embodiments. The difference between the embodiment shown in FIG. 5 to FIG. 8C and the previous embodiments is that, the first structure 140A shown in FIG. 5 to FIG. 8C includes a limiting slot S2 in an arc-shape and is formed on the bracket 110A, and the second structure 150A includes at least one limiting column P3 (shown as one) formed on the relay gear 130A. The limiting column P3 is positioned in the limiting slot S2, and two opposite ends of the limiting slot S2 are configured to stop the limiting column P3, so as to limit the relay gear 130A to have the second maximum rotation stroke. That is, as shown in FIG. 8A or FIG. 8C, when the limiting column P3 touches either of the two opposite ends of the limiting slot S2 as the relay gear 130A rotates, the relay gear 130A is at a limit position thereof. Accordingly, the moving distance of the relay gear 130A rotating from the state of FIG. 8A to the state of FIG. 8C or from the state of FIG. 8C to the state of FIG. 8A is the second maximum rotation stroke. According to the change of the position of the limiting column P3 in the limiting slot S2, the range by which the relay gear 130A can be rotated is provided, so as to limit the relay gear 130A to have the second maximum rotation stroke.

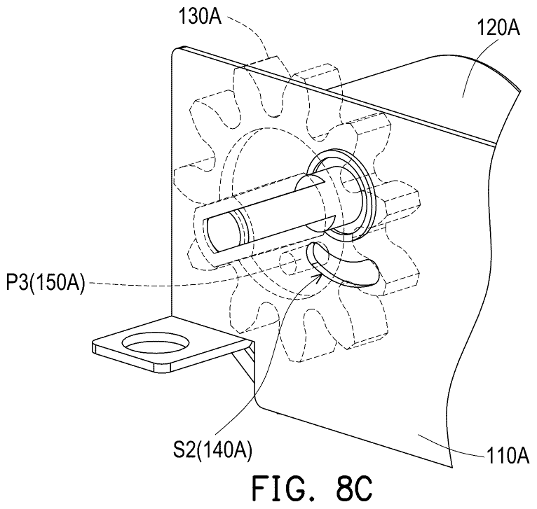

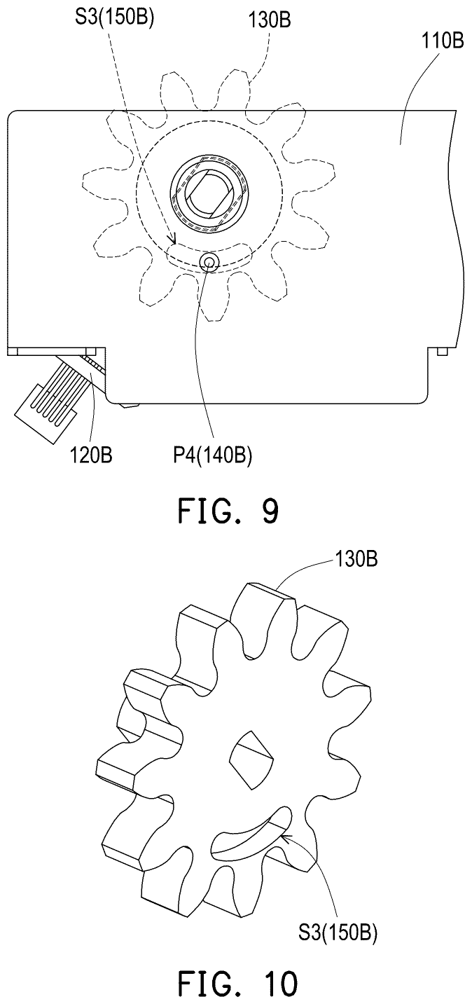

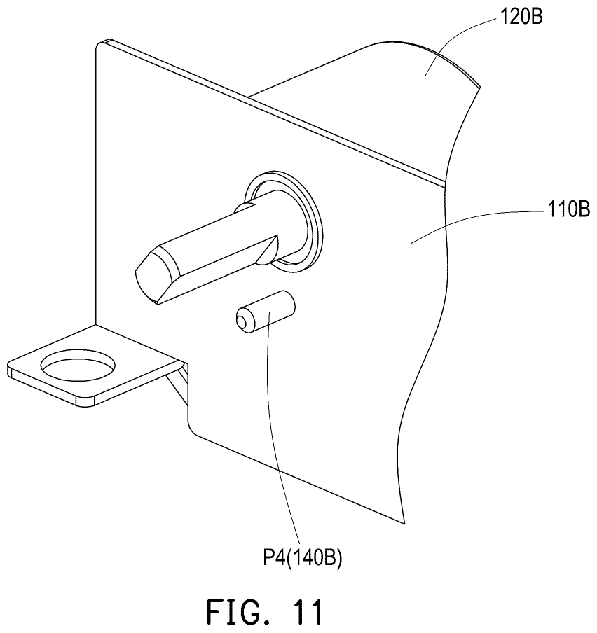

FIG. 9 is a schematic view of some components of the focusing module according to another embodiment of the disclosure. FIG. 10 is a perspective view of the relay gear according to FIG. 9. FIG. 11 is a perspective view of the bracket and drive unit according to FIG. 9. In the embodiments shown in FIG. 9 to FIG. 11, the configuration and action modes of a bracket 110B, a drive unit 120B, a relay gear 130B, a first structure 140B, and a second structure 150B are similar to the configuration and action modes of the bracket 110A, the drive unit 120A, the relay gear 130A, the first structure 140A, and the second structure 150A. The difference between the embodiments shown in FIG. 9 to FIG. 11 and the previous embodiments is that, the first structure 140B shown in FIG. 9 to FIG. 11 includes at least one limiting column P4 (shown as one) formed on the bracket 110B, and the second structure 150B includes a limiting slot S3 in an arc-shape and is formed on the relay gear 130B. The limiting column P4 is positioned in the limiting slot S3, and two opposite ends of the limiting slot S3 are configured to stop the limiting column P4, so as to limit the relay gear 130B to have the second maximum rotation stroke. Specifically, according to the change of the position of the limiting column P4 in the limiting slot S3, the range by which the relay gear 130B can be rotated is provided, so as to limit the relay gear 130B to have the second maximum rotation stroke.

According to the projector of the embodiment of the disclosure, since the focusing module is connected to the focusing ring of the lens module, when the drive unit of the focusing module is actuated, the relay gear can be driven to rotate, and then the focusing ring of the lens module is driven to rotate to adjust the focal length of the lens module. At the same time, since the second maximum rotation stroke of the relay gear is smaller than the first maximum rotation stroke of the focusing ring, the relay gear first rotates to the limit position thereof before the focusing ring reaches the limit position thereof and prevent the focusing ring from continuing to rotate.

In summary, the embodiments of the disclosure have at least one of the following advantages or effects. In the focusing module of the embodiment of the disclosure, the second structure on the relay gear and the first structure on the bracket can stop each other when the relay gear rotates relatively to the bracket, so as to limit the maximum rotation stroke of the relay gear to be smaller than the maximum rotation stroke of the focusing ring. Accordingly, before the focusing ring rotates to the limit position thereof, the relay gear first rotates to the limit position thereof to stop the focusing ring from continuing to rotate, so that the excess output force from the drive unit can be borne on the relay gear, so as to prevent the output force provided to the focusing ring by the drive unit from acting on the lens module and causing the image projected by the lens module to jitter or shift. Moreover, the output force provided by the focusing module can be prevented from acting on the lens module to produce a reaction force on the focusing module, so that the focusing module is not worn out due to repeated long-term bearing of the reaction force.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A focusing module suitable for a lens module, wherein the lens module comprises a focusing ring, the focusing ring has a first maximum rotation stroke, the focusing ring is suitable for rotation to adjust a focal length of the lens module, and the focusing module is connected to the focusing ring and comprises:
a bracket;
a drive unit disposed on the bracket;
a relay gear disposed on the bracket and connected to the drive unit, wherein the focusing ring is connected to the relay gear, and the drive unit is configured to drive the relay gear to rotate to drive the focusing ring to rotate;
a first structure formed on the bracket; and
a second structure formed on the relay gear, wherein when the relay gear rotates relatively to the bracket, the first structure and the second structure are suitable for stopping each other to limit rotation of the relay gear, so that the relay gear has a second maximum rotation stroke, and the second maximum rotation stroke is smaller than the first maximum rotation stroke.

2. The focusing module as claimed in claim 1, wherein the first structure comprises at least one limiting column formed on the bracket, the relay gear has a toothed area and a non-toothed area, the toothed area is connected to the focusing ring, the non-toothed area has two stopping surfaces to form the second structure, the at least one limiting column is positioned on a rotation path of the two stopping surfaces, and the two stopping surfaces are configured to stop the at least one limiting column, so as to limit the relay gear to have the second maximum rotation stroke.

3. The focusing module as claimed in claim 2, wherein the number of the at least one limiting column is two.

4. The focusing module as claimed in claim 1, wherein the first structure comprises a limiting slot formed on the bracket, the second structure comprises at least one limiting column formed on the relay gear, the at least one limiting column is positioned in the limiting slot, two opposite ends of the limiting slot are configured to stop the at least one limiting column, so as to limit the relay gear to have the second maximum rotation stroke.

5. The focusing module as claimed in claim 4, wherein the limiting slot is formed in an arc-shape.

6. The focusing module as claimed in claim 1, wherein the first structure comprises at least one limiting column formed on the bracket, the second structure comprises a limiting slot formed on the relay gear, the at least one limiting column is positioned in the limiting slot, two opposite ends of the limiting slot are configured to stop the at least one limiting column, so as to limit the relay gear to have the second maximum rotation stroke.

7. The focusing module as claimed in claim 6, wherein the limiting slot is formed in an arc-shape.

8. The focusing module as claimed in claim 1, further comprising a driven gear, wherein the driven gear is connected to the focusing ring and engaged with the relay gear.

9. The focusing module as claimed in claim 1, wherein the first maximum rotation stroke is a distance that the focusing ring moves at a maximum rotation angle, and the maximum rotation angle is 60 degrees.

10. A projector, comprising:
an illumination module configured to provide an illumination light beam;
a light valve disposed on a transmission path of the illumination light beam and configured to convert the illumination light beam into an image light beam;
a lens module disposed on a transmission path of the image light beam and configured to project the image light beam, wherein the lens module comprises a focusing ring, the focusing ring has a first maximum rotation stroke, and the focusing ring is suitable for rotation to adjust a focal length of the lens module; and
a focusing module connected to the focusing ring, wherein the focusing module comprises:
a bracket;
a drive unit disposed on the bracket;
a relay gear disposed on the bracket and connected to the drive unit, wherein the focusing ring is connected to the relay gear, and the drive unit is configured to drive the relay gear to rotate to drive the focusing ring to rotate;
a first structure formed on the bracket; and
a second structure formed on the relay gear, wherein when the relay gear rotates relatively to the bracket, the first structure and the second structure are suitable for stopping each other to limit rotation of the relay gear, so that the relay gear has a second maximum rotation stroke, and the second maximum rotation stroke is smaller than the first maximum rotation stroke.

11. The projector as claimed in claim 10, wherein the first structure comprises at least one limiting column formed on the bracket, the relay gear has a toothed area and a non-toothed area, the toothed area is connected to the focusing ring, the non-toothed area has two stopping surfaces to form the second structure, the at least one limiting column is positioned on a rotation path of the two stopping surfaces, and the two stopping surfaces are configured to stop the at least one limiting column, so as to limit the relay gear to have the second maximum rotation stroke.

12. The projector as claimed in claim 11, wherein the number of the at least one limiting column is two.

13. The projector as claimed in claim 10, wherein the first structure comprises a limiting slot formed on the bracket, the second structure comprises at least one limiting column formed on the relay gear, the at least one limiting column is positioned in the limiting slot, and two opposite ends of the limiting slot are configured to stop the at least one limiting column, so as to limit the relay gear to have the second maximum rotation stroke.

14. The projector as claimed in claim 13, wherein the limiting slot is formed in an arc-shape.

15. The projector as claimed in claim 10, wherein the first structure comprises at least one limiting column formed on the bracket, the second structure comprises a limiting slot formed on the relay gear, the at least one limiting column is positioned in the limiting slot, and two opposite ends of the limiting slot are configured to stop the at least one limiting column, so as to limit the relay gear to have the second maximum rotation stroke.

16. The projector as claimed in claim 15, wherein the limiting slot is formed in an arc-shape.

17. The projector as claimed in claim 10, wherein the focusing module further comprises a driven gear, and the driven gear is connected to the focusing ring and engaged with the relay gear.

18. The projector as claimed in claim 10, wherein the lens module comprises a lens barrel, the focusing ring is sleeved on an outer wall of the lens barrel, the focusing ring has a limiting slot, the lens barrel has a limiting column, the limiting column is positioned in the limiting slot, and two opposite ends of the limiting slot are configured to stop the limiting column, so as to limit the focusing ring to have the first maximum rotation stroke.

19. The projector as claimed in claim 10, wherein the first maximum rotation stroke is a distance that the focusing ring moves at a maximum rotation angle, and the maximum rotation angle is 60 degrees.
